(19) United States
(12) Patent Application Publication
(10) Pub. No.: US 2002/0078131 A1
(43) Pub. Date: Jun. 20, 2002

(54) Method and system for presenting operational data by geographical location

(75) Inventors: Susan J. Dowd, Westminster, CO (US); Steven C. Laufmann, Louisville, CO (US); Christopher J. Peltz, Longmont, CO (US); Gary M. Smithrud, Fort Collins, CO (US); Benjamin E. Hansen, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO

(21) Appl. No.: 09/896,927

(22) Filed: Jun. 28, 2001

Related U.S. Application Data
(60) Provisional application No. 60/214,622, filed on Jun. 28, 2000.

(51) Int. Cl. G06F 15/16

(52) U.S. Cl. 709/201

(57) ABSTRACT

A method and system for presenting information by geographical location in a geographical region includes a map data input and an operational data input. The map data input provides map data of a geographical region including geographical locations within the geographical region. The operational data input provides operational data associated with the geographical locations within the geographical region. A processor processes the map data and the operational data to generate a map display of the geographical region for presenting operational data by geographic location. The processor classifies the operational data into classifications and then associates the classifications and the operational data with the map data to generate the map display.

### CROSS-REFERENCES TO RELATED APPLICATIONS

This applications claims the benefit of U.S. Provisional Patent Application Serial No. 60/214,622, filed on Jun. 28, 2000 and entitled “Method and System for Presenting Operational Data by Geographic Location,” the entirety of which is incorporated by reference herein for all purposes.

### BACKGROUND OF THE INVENTION

The present invention relates generally to methods and systems for presenting high level information pertaining to operational data including telephone service data by geographical location.

Decision makers working on high level tasks generally have limited time and resources to analyze operational data to identify problems and then resolve those problems. For instance, executives in the telecommunications industry need to analyze massive quantities of data related to telephone operations to determine if there are any problems with telephone service provided by the telecommunications industry or a particular service provider in the telecommunications industry. In the telecommunications industry, operational data can include information pertaining to telecommunications operations, physical plant, and/or customer care. As one skilled in the art will appreciate, it can be very time consuming and difficult to analyze all of the massive quantities of raw operational data. Thus, without a reasonable way to organize and/or aggregate the data, the massive quantities of raw operational data can become difficult, if not impossible to work with, and thus rendered useless.

### BRIEF SUMMARY OF THE INVENTION

In one embodiment, a method for presenting data including telecommunications operational data and map data using a plurality of data groups is provided. The method comprises: receiving the map data; receiving the telecommunications operational data; classifying the telecommunications operational data into the plurality of data groups; associating the plurality of data groups and the telecommunications operational data with the map data; assigning a plurality of identifiers to the plurality of data groups, wherein the plurality of identifiers indicate a ranking of importance for the plurality of data groups; and generating a display including the associated plurality of data groups with the assigned plurality of identifiers, the telecommunications operational data, and the map data.

In another embodiment, a system for presenting data including telecommunications operational data, map data, a plurality of data groups, and a plurality of identifiers, wherein the plurality of identifiers indicate a ranking of importance for the plurality of data groups is provided. The system comprises: a map data input configured to receive the map data; a telecommunications operational data input configured to receive the telecommunications operational data; and a processor coupled to the map data input and the telecommunications operational data input and configured to classify the telecommunications operational data into the plurality of data groups, associate the plurality of data groups and the telecommunications operational data with the map data, assign the plurality of identifiers to the plurality of data groups, and generate a display including the associated plurality of data groups with the assigned plurality of identifiers, telecommunications operational data, and map data.

A more complete understanding of the present invention may be derived by referring to the detailed description of preferred embodiments and claims when considered in connection with the figures.

### BRIEF DESCRIPTION OF THE DRAWINGS

FIG. 1 illustrates a system for presenting operational data including telephone service data by geographic location;

FIG. 2 illustrates an exemplary map display of a single region 5 generated in accordance with the method and system of the present invention;

FIG. 3 illustrates an exemplary tabular display generated in accordance with the method and system of the present invention;

FIG. 4 illustrates an exemplary map display of a multiple state region generated in accordance with the method and system of the present invention;

FIG. 5 illustrates a graphical user interface (GUI) for a user to request reports for presentation by the method and system of the present invention;

FIG. 6 illustrates a report title and legend for a map display presented in accordance with the method and system of the present invention;

FIG. 7 illustrates a tool menu providing a set of tools for the user to manipulate a map display presented in accordance with the method and system of the present invention;

FIG. 8 illustrates a report summary display of a single service area generated in accordance with the method and system of the present invention; and

FIG. 9 illustrates a detailed tabular display for a selected service area generated in accordance with the method and system of the present invention.

### DETAILED DESCRIPTION OF THE INVENTION

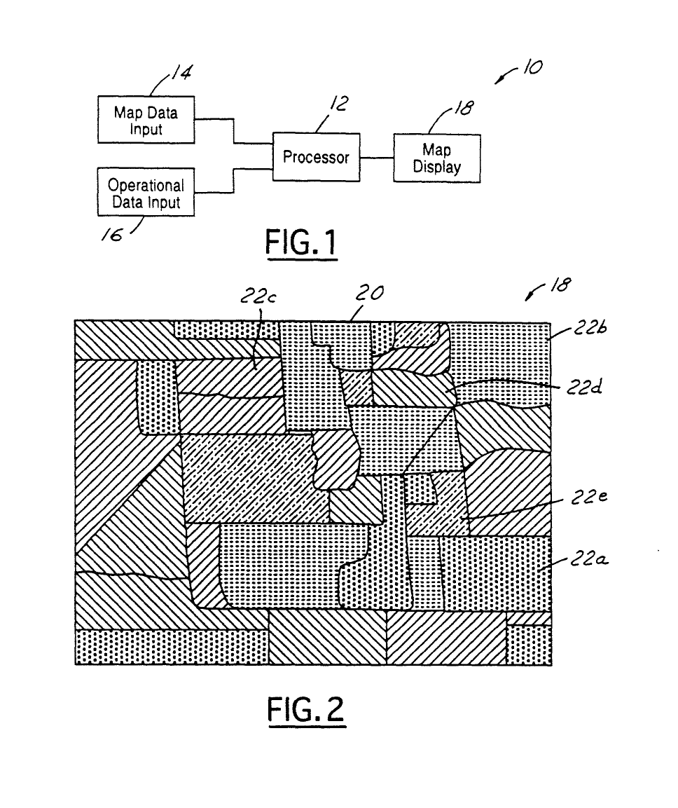

Referring now to FIG. 1, a system 10 for presenting operational data by geographic location according to one embodiment is shown. System 10 converts raw operational data into useful information by processing the operational data and then presenting the processed operational data in a manner designed to enhance human cognitive capabilities. System 10 is a presentation tool that displays information pertaining to telecommunications operational data including operations, physical plant, and consumer care by geographic location. In accordance with the illustrated embodiment, system 10 presents information related to telecommunications service in various localized service areas across a service region of a telecommunications service provider.

Telecommunications service providers receive thousands of telecommunications service requests each day. These requests may include outside dispatchable work related to plain old telephone service (POTS), designed services, such as DSL and other bandwidth services, cable services, and the like. Users of system 10 are expected to be working on high level tasks related to the management of the telecommunications service requests, for example, performing work of a strategic nature. A basic assumption of system 10 is that the users generally will have limited time and resources both to look for and identify problems and to resolve those problems in the handling of the service requests. System 10 processes the operational data representing the service requests and then presents the results in a manner that accommodates the user's limited time and resources. The operational data can include varied information relating to different aspects of the telecommunications service requests and system 10 can present the results of this varied information in different reports. Based on the processing and presentation of the operational data by system 10, the users can make strategic decisions.

System 10 includes a processor 12, a map data input 14, a telecommunications service operational data input 16, and a map display 18. Processor 12 receives map data from map data input 14 and receives operational data from the telecommunications service operational data input 16. In one embodiment, the map data represents various individual service areas in an overall or larger service area of a telecommunications service provider. In one embodiment, the operational data represents daily telecommunications operational information with respect to the service areas of the telecommunications service provider. Each service area has its own operational data representing information regarding telecommunications services managed and handled by the service area. The operational data may represent daily telecommunications operational information with respect to various telecommunications aspects of the management and handling of the telecommunications services by each service area, i.e., various reports. The operational data includes operational data values to quantify the meaning of the operational data.

In general, processor 12 processes the map data and the operational data to generate a map display 18 for presenting the operational data by geographic location. Processor 12 classifies the operational data into classifications and then associates the classifications and the operational data with the map data to generate map display 18. In our embodiment, processor 12 performs a three way join of the classifications, the operational data, and the map data to generate map display 18. Processor 12 can also generate a tabular display of map display 18.

In one embodiment, processor 12 classifies the operational data by using a clustering algorithm, which dentifies and leverages natural breaks in the operational data in order to cluster the operational data values into associated groupings. The clustering algorithm compares the operational data for a particular measurement to determine the relationship among the operational data values. Based on the comparison, the clustering algorithm groups together data values that are similar into data value groups. The clustering algorithm separates the data value groups from one another. The number of data values in any data value group is not fixed and varies with the operational data. In one embodiment, the clustering algorithm clusters the operational data into five different data groupings.

Referring now to FIG. 2, with continual reference to FIG. 1, a map display 18 generated by processor 12 is shown. Map display 18 includes an entire region 20 having a plurality of individual geographical areas 22. In one embodiment, each individual area 22 represents a telecommunications central office or wire center. Each central office provides telecommunications services to consumers located within individual geographical areas 22.

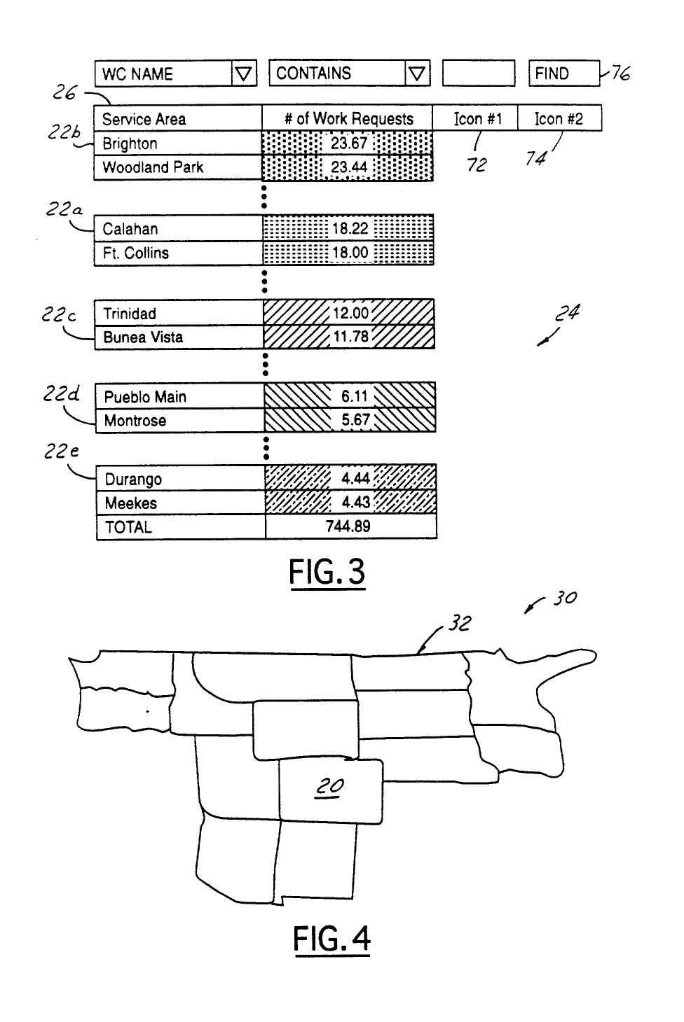

Referring now to FIG. 3, with continued reference to FIGS. 1-2, a tabular display 24 generated by processor 12 based on map display 18 is shown. For each service area 22, tabular display 24 displays the operational data value associated with that service area. For instance, service area 22a for the Calhan service area has an operational data value of “18.22”, service area 22b for the Brighton service area has an operational data value of “23.67”, service area 22c for the Buena Vista service area has an operational data value of “11.78”, and the like.

Processor 12 assigns a color or gray scale shading for each data value grouping, and then colors or shades geographical area 22 associated with the operational data on map display 18 and tabular display 24. The breaks between the data value groupings are the boundaries for the color or shading bands. In one embodiment, processor 12 uses a five valued graduated color scheme or gray scale shading and assigns a different color or gray shading to each one of the five different data value groupings. For example, the color scheme goes from red (hot) to blue (cold). Similarly, the gray scale shading goes from dark (hot) to light (cold). For example, as shown on map display 18 and tabular display 24, geographical area 22a has a red or dark shading; geographical area 22b has an orange or medium dark shading; geographical area 22c has a purple or medium gray shading; geographical area 22d has a light purple or medium light shading; and geographical area 22e has a blue or light shading.

The colors and gray scale shadings indicate the importance of a geographic service area with respect to an operational data report. The colors and gray shadings provide the means to quickly identify which service areas deserve the most attention. The color bands and gray scale shadings are based on a comparison among the various geographic areas in a report for the specific report and selected report options. The colors and gray scales indicate the relative importance of the regions in the view in comparison with one another.

Because the comparison is generally different for different reports they are calculated for each different report each time the data is updated. As a result, red values do not necessarily indicate a problem. Rather, they indicate that certain values are more deserving of attention than other values in a report. For example, a service area may have an unusual amount of repair calls as compared to other service areas. Processor 12 would assign this service area with a red color or dark shading when presenting a map display of a repair call report. Another service area may have an unusual amount of service installations. Processor 12 would assign this service area with a red color or dark shading when presenting a map display of a service installation report.

The same color or gray scale banding scheme is used throughout the data presentation so even tabular data corresponding to the map data is presented over a background of the same color or gray scale. The user viewing map display 18 can then analyze the operational data with respect to geographical locations or service areas by the color or shading of the map display. By using colors and gray scales, the method and system of the present invention provides as much meta information, i.e., information about the information, as possible to the users to assist the users in understanding the presented information as quickly as possible.

In accordance with our embodiment of the present invention, the clustering algorithm of the present invention indicates the outlying values, i.e., those values that demand the most attention. The approach performed by the clustering algorithm is very dynamic and allows the method and system of the present invention to automatically respond to the actual data values, rather than a pre-defined set of expectations on the data. This also means that the data value groupings can follow the data values so if most of the data is skewed toward the higher end of the report scale, the user will see more reports in the red color band or dark gray scale band. Data skewed toward the lower end of the scale will result in a bluer or lighter map.

Telecommunications service operational data input 16 provides the operational data to processor 12 for the clustering algorithm to classify. In one embodiment, input 16 includes a Workforce Administrator/Dispatch Out (WFA/DO) system responsible for managing and monitoring telecommunications service work requests. The WFA/DO system 16 provides operational data information related to the telecommunications services provided by each service area 22 to processor 12. As is known in the telecommunications service provider art, input 16 may also include a WFAStore system for storing operational data information, a system for providing information related to finished work requests, and a system for providing information related to unfurnished work requests. Input 16 may also include systems for providing static information relating to telecommunications services. Periodically, for instance after a work day, input 16 provides the operational data to processor 12. Processor 12 then processes the operational data to generate a new map display 18 for use the next work day.

As an example, the operational data includes data regarding telecommunications operations, physical plant, and customer care of a telecommunications service provider. The operational data includes data related to telecommunication service work requests across an entire region 20 and each individual geographical area or service area 22 of the telecommunications service provider. For instance, a work request may be a customer requesting telecommunications services to be enabled or repaired. In addition, each work request may have associated information. Region 20 may be a large region such as a state. Region 20 may also be part of a larger region such as a region having multiple states. In such a large region there may be on the order of thousands of work requests each day. In region 20 there are multiple wire centers 22. In a typical day, a 14 state region may receive about 25,000 closed work requests, such that each wire center will accumulate about 7500 work requests. Thus, the method and system of the present invention maps a 25,000 30 table of work request information into a 1250 7500 wire center accumulations table.

Processor 12 processes the operational data to generate a plurality of telecommunication service reports. These reports may include missed commitments, completed<N hours, defects (I and R defects), number of work requests, number of work requests (normalized), held orders, JEPs, escalations, cause codes (POTS only), disposition codes (POTS only), service types, work time to price ratio, drive time to work time ratio, customer demand, and customer density. In addition, the system may produce a fallout summary report available for each reporting day showing how many work requests dropped out of processing for various reasons in processing the work day's data.

In one embodiment, system 10 presents operational data based on the following guiding principles: visual presentation, comparative data, floating color or gray scale shading bands, comparisons within and across regions, geography importance, and rapid response. Human cognition is known to obtain and process large amounts of visual information in parallel while most other forms of presentation are processed serially resulting in a more time consuming and complicated information gathering process. Thus, system 10 uses primarily visual presentations. Even tabular data is augmented with as much visual information as possible by using colored or gray shaded backgrounds to augment visual scanning. System 10 uses color or gray shading to indicate to users where they should be focusing their attention. System 10 provides a means that minimizes the time required to find data that deserves attention. System 10 performs this feature through comparative analysis of the various operational data within a report.

In one embodiment, system 10 uses a data clustering algorithm to assign data to a set of five color or gray scale bands. The data clustering algorithm looks for natural breaks in the data and shows the areas that need the most attention. If more than one distinct value is seen in a given data set there will always be at least one service area item that will be shown in the red color or the dark shading, indicating the service area most deserving of attention for a particular report. This is completely independent of any threshold that might be performed by other systems of the prior art. System 10 is designed to allow users to move quickly and easily between levels of view for the same basic operational data. This allows users to compare different areas within their domain and to compare their domain with the domain of their peers. Geospatial relationships between service areas are important. It is often meaningful to view various results in one service area with respect to the results of other service areas. For example, in what ways is a particular service area performing as compared to its peers, especially for those service areas that are geographically adjacent. System 10 performs as much as possible of its processing prior to a user request. All daily operational data feeds and processing can be performed at night and then released together early in the morning. System 10 uses data structures and files that promote the fastest possible runtime responses.

Referring now to FIG. 4, with continued reference to FIGS. 1-2, a map display 30 of an entire multiple state region 32 is shown. Multiple state region 32 includes region or state 20 and other states (regions) as shown. Processor 12 generates map display 30 of multiple state region 32 in a manner similar to the generation of map display 18.

Processor 12 may be configured to aggregate the operational data for each wire center in a state and then process the aggregate operational data to present the operational data of each state as a whole for comparison with other states. In this embodiment, processor 12 assigns all of the service areas in a state as one of the five colors or gray shadings as a function of the operational data for the respective state. Processor 12 also may be configured to individually process the operational data for each service area in a state as described above to present the operational data of each service area individually for comparison with service areas in the same state and other state. In this embodiment, processor 12 assigns each service area in each state as one of the five colors or gray shadings as a function of the operational data for the respective service area.

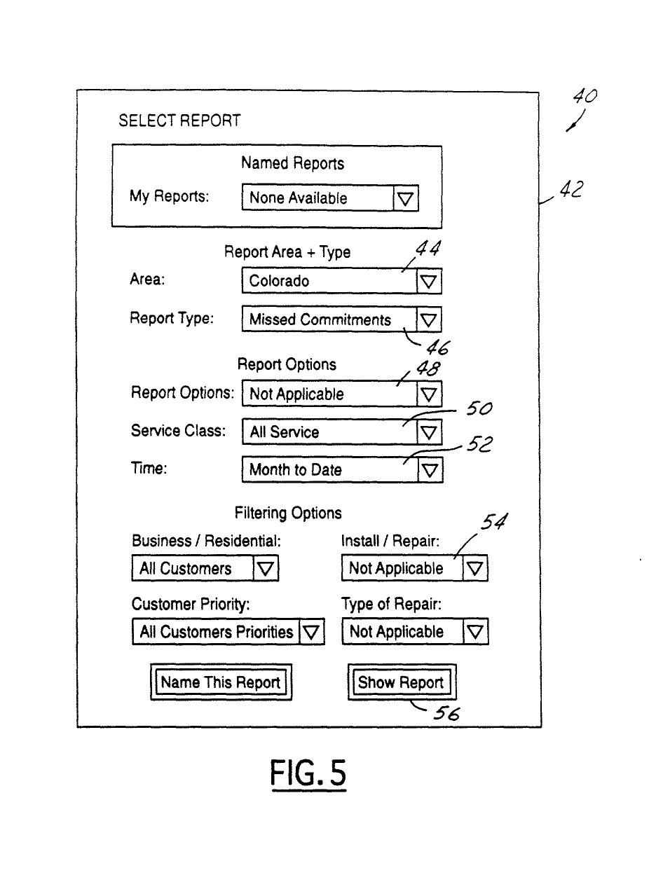

In operation, processor 12 provides a graphical user interface (GUI) 40 as shown in FIG. 5 for use by a user according to one embodiment. GUI 40 is a menu that provides all the available reports and report options. Each report may have different report options such that each report has multiple report types. GUI 40 includes a “Select Reports” dialog box 42, which provides a menu for a user to request processor 12 to display a report of operational data on a map display or a tabular display in the manner described above. For instance, Select Reports dialog box 42 includes a dialog box 44 for the user to request a region for analysis; a dialog box 46 for the user to request a report type for the selected region; a dialog box 48 for the user to request report options for the selected report; a dialog box 50 for the user to request a service class for the selected report options; and a dialog box 52 for the user to request a time period for analysis of the operational data. Select Reports dialog box 42 also includes dialog boxes 54 for the user to input filtering options for the selected report. After entering the various information into the dialog boxes to request a report the user selects “Show Report” button 56.

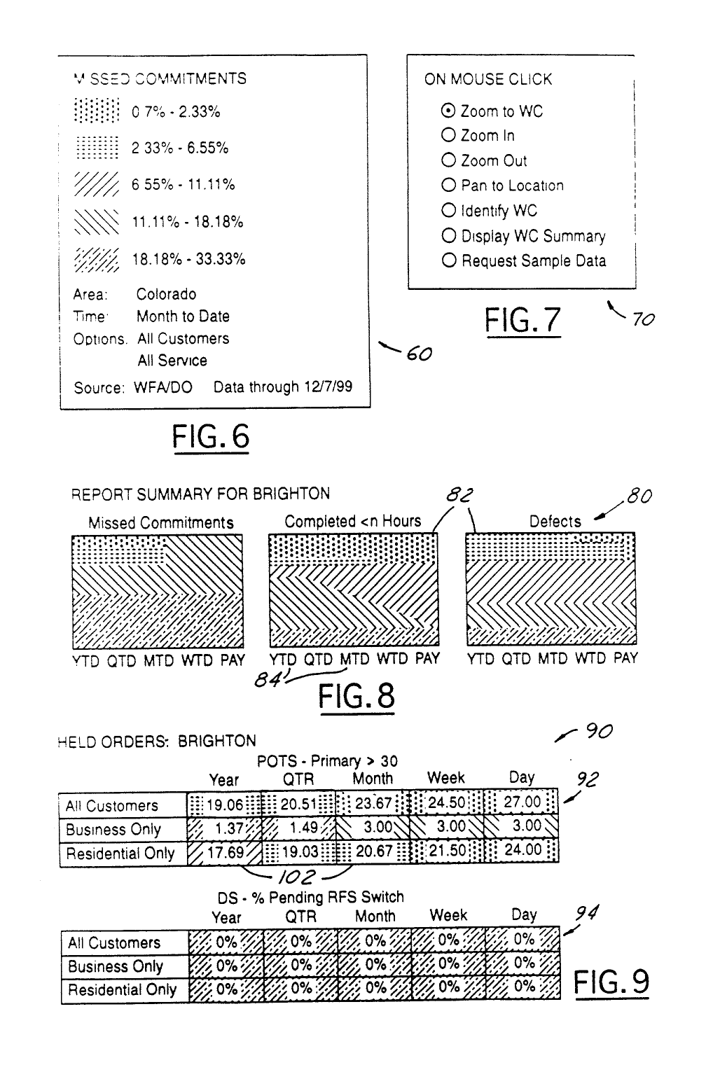

In response, processor 12 displays a map display such as map display 18 of the requested report. In one embodiment, there are five main components in the view of the map display displayed by processor 12, including the report title, a legend, the map display, a map scale bar, and a tool menu. FIG. 6 illustrates the report title and legend 60. The report title describes the set of options selected in specifying the map. Legend 60 describes the meaning of the coloring or gray shading of map display 18. The top portion of legend 60 describes the report type and any report options for map display 18 (e.g., Missed Commitments, All Customers, All Service). The middle portion of legend 60 describes the meaning of the operational data displayed on map display 18, including an abbreviated description of derivation of the operational data and the definitions of the color or gray scale bands used for the particular report. Note that the color and gray scale bands are calculated independently for each different report. For most reports, the color and gray scale bands indicate a range of values by showing a starting number and an ending number. In addition, the bottom portion of legend 60 includes two data indicators. On the left is a description of the source of the information in the report. On the right is a data time stamp indicating the date of the most recent data being presented in the report. Under normal operating conditions this will be the previous day (yesterday). Scale bar 72 indicates the approximate scale map display 18.

FIG. 7 illustrates a tool menu 70 providing a set of tools for the user to manipulate map display 18 according to one embodiment. To zoom in or out on map display 18, the user selects the appropriate zoom function in tool menu 70 and then clicks on map display 18. The point on map display 18 where the user clicked becomes the center of the updated map display 18. To zoom in a specific service area of map display 18 the user selects the tool labeled “Zoom to WC” and then clicks on map display 18. That service area will then become the focus of map display 18. Depending on the specific report displayed in map display 18 the label for this tool will vary.

The user may also zoom to the next larger region by selecting the “Zoom to Larger Region” link. This will bring up a new map display with the same report type and report options, but viewed at the next level up in the view hierarchy. From a map of an individual state this function will display the same report but at the multiple state region level. The inverse of this function is seen at the “Entire Region” level where a tool is available to “Display State Detail Map”. Clicking on a state in the region view will display the same report, but for the state view, which presents data by service area, i.e., wire center, (or by zip code for demand data reports).

To get additional information about a region of map display 18, the user selects the “identify” tool and clicks on the region in question. A small box with additional information about the region will be displayed. The box contains the name of the region and the operational data value for the region for the particular report. Once a map display is displayed the user can obtain a tabular listing 24 (see FIG. 3) of the map data. Tabular listing 24 contains the textual data upon which the map presentation is based. In tabular listing 24 the operational data is in two columns with the first column showing the service area name and the second column showing the report operational data values (one per service area) being shown on map display 18. For each row in tabular display 24 there are two icons 72, 74 (depending on the specific report) to the right of the operational data values. Map icon 72 performs the same functionality as the “Zoom to WC” function taking the user back to map display 18 and zooming to the selected service area. Summary icon 74 performs a report summary function for the selected service area. The report summary function is described below.

At the bottom of tabular display 24 is the “total” for all items shown on map display 18. The total number is in the appropriate units for the report being presented. For percentage values, the total number is the percentage of values across the entire report. For values that are counts, the total number is the sum of all values in the report.

Once a report is displayed in tabular display 24 the user can perform a search function against the data in the tabular display. Tabular display 24 includes a find dialog box 76 having three small boxes and a “Find” button. The first small box offers a choice of variables in the operational data that can be searched. The second small box contains a set of search operations. The third small box allows the user to type in the full or partial value of interest. For example, with a display of the “Held Orders” report for Colorado the user can enter the following values: “WCNAME” contains “Denver”. In response, tabular display 24 displays only the eight service areas that are specified in the subset: Denver Main, South, Southeast, Southwest, East, West, North, and Northeast. The total number is only for this subset. Tabular display 24 can be downloaded for use in other applications.

Referring now to FIG. 8, with continual reference to FIG. 2, a report summary 80 generated by processor 12 for a selected service area is shown. Initially, it is noted that processor 12 generates map displays for each report to include time related information. For instance, processor 12 may generate a map display for a report to include only the most recent work day's results or may generate a map display for the same report to include the most recent work week's results. To generate a map display for a report only including the most recent work day's results processor 12 processes and compares the operational data for the most recent work day. Similarly, to generate a map display for a report including the most recent work week's results processor 12 processes and compares the operational data for the most recent work week. Processor 12 may generate five map displays for a single report with each map display reflecting different time periods. These time periods include recent day, week to recent day, month to recent day, quarter to recent day, and year to recent day. Report summary 80 provides a smoothed method for comparative tending over time for a particular report of a particular service area. Report summary 80 displays all of the operational data information associated with a selected service area. Report summary 80 includes a plurality of histograms 82. Each histogram displays operational data information of the selected service area (or state or zip code region) for a respective report. Processor 12 may generate thirteen different reports as identified above and report summary 80 includes thirteen histograms each corresponding to a respective report for the selected service area.

Reports summary 80 displays a synopsis of all the reports available for the selected service area using a graphic histogram 82 to indicate the color or gray scale bands for each report to indicate the color and gray scale bands that the various report options fall into for the selected service area. Each histogram 82 displays all five time bands 84 to indicate trending over time. As explained above, each report includes options to define a report type for that particular report. Some reports may have many different report types while other reports only have a few different report types. Each time band 84 in histograms 82 represents the percentage of individual report types of a report that are assigned one of the five colors or gray scale shadings for the selected service area. Consequently, reports summary 80 is a one page sheet roll up of a few thousand reports.

Referring now to FIG. 9, with continual reference to FIG. 8, a detailed tabular display 90 for a report of a selected service area is shown. As an example, detailed tabular display 90 displays all of the operational data for each report type of the report “Held Orders” for the service area “Brighton”. Detailed tabular listing 90 includes a plurality of tabular listings 92 and 94 associated with a report type of the report. Each tabular listing 92 and 94 displays operational data for each option of the report types and for each one of the five time periods in cells 102. Each cell 102 in tabular listings 92 and 94 is color or gray shaded as it would appear on a map display. Detailed tabular display 90 is configured such that upon a user selecting a cell in a tabular listing 92 and 94, a map display associated with the selected cell is displayed. The map display, for example, map display 18, is a display of the operational data for all of the service areas in a region for report type and report option of a report associated with the selected cell. Similar to moving from detailed tabular display 90 to map display 18, the user can select a service area on the map display to obtain the detailed tabular display for the selected service area.

In addition to presenting information regarding past operational data, processor 12 may to present forecasting operational data. For instance, processor 12 may present two reports: percent utilization and change factor. The change factor measures the magnitude of the difference between predicted future demand (based on the previous yearly trend) and the actual forecast in a database. Forecasts for yearly periods are each compared with the previous yearly trend.

In conclusion, the present invention provides novel systems and methods for presenting operational data by geographic location. While detailed descriptions of one or more embodiments of the invention have been given above, various alternatives, modifications, and equivalents will be apparent to those skilled in the art. Therefore, the above description should not be taken as limiting the scope of the invention, which is defined by the appended claims.

What is claimed is:

1. A method for presenting data including telecommunications operational data and map data using a plurality of data groups comprising:
receiving the map data;
receiving the telecommunications operational data;
classifying the telecommunications operational data into the plurality of data groups;
associating the plurality of data groups and the telecommunications operational data with the map data;
assigning a plurality of identifiers to the plurality of data groups, wherein the plurality of identifiers indicate a ranking of importance for the plurality of data groups; and
generating a display including the associated plurality of data groups with the assigned plurality of identifiers, the telecommunications operational data, and the map data.

2. The method of claim 1, wherein generating the display comprises generating a map display.

3. The method of claim 1, wherein generating the display comprises generating a tabular display.

4. The method of claim 1, wherein classifying the telecommunications operational data into the plurality of data groups comprises grouping the telecommunications operational data into the plurality of data groups based on a value of the telecommunications operational data.

5. The method of claim 1, wherein assigning the plurality of identifiers to the plurality of data groups comprises assigning a graduated color scheme to the plurality of data groups, wherein the graduated color scheme corresponds to the ranking of importance.

6. The system of claim 5, wherein the graduated color scheme comprises a plurality of colors corresponding to the ranking of importance, wherein the plurality of colors comprise a dark color, plurality of medium colors, and a light color.

7. The method of claim 6, wherein assigning a graduated color scheme to the plurality of data groups comprises assigning the dark color to the data group corresponding to a highest ranking in the ranking of importance.

8. The method of claim 7, wherein assigning a graduated color scheme to the plurality of data groups comprises assigning the light color to the data group corresponding to a lowest ranking in the ranking of importance.

9. The method of claim 8, wherein assigning a graduated color scheme to the plurality of data groups comprises assigning the plurality of medium colors to the data group corresponding to a plurality of medium rankings in between the highest and lowest rankings in the ranking of importance.

10. The system of claim 1, wherein the gray scale shading scheme comprises a plurality of shadings corresponding to the ranking of importance, wherein the plurality of shadings comprise a dark shading, plurality of medium shadings, and a light shading.

11. The method of claim 10, wherein assigning a gray scale shading scheme to the plurality of data groups comprises assigning the dark shading to the data group corresponding to a highest ranking in the ranking of importance.

12. The method of claim 11, wherein assigning a gray scale shading scheme to the plurality of data groups comprises assigning the light shading to the data group corresponding to a lowest ranking in the ranking of importance.

13. The method of claim 12, wherein assigning a gray scale shading scheme to the plurality of data groups comprises assigning the plurality of medium shadings to the data group corresponding to a plurality of medium rankings in between the highest and lowest rankings in the ranking of importance.

14. A system for presenting data including telecommunications operational data, map data, a plurality of data groups, and a plurality of identifiers, wherein the plurality of identifiers indicate a ranking of importance for the plurality of data groups, the system comprising:
a map data input configured to receive the map data;
a telecommunications operational data input configured to receive the telecommunications operational data; and
a processor coupled to the map data input and the telecommunications operational data input and configured to classify the telecommunications operational data into the plurality of data groups, associate the plurality of data groups and the telecommunications operational data with the map data, assign the plurality of identifiers to the plurality of data groups, and generate a display including the associated plurality of data groups with the assigned plurality of identifiers, telecommunications operational data, and map data.

15. The system of claim 14, wherein the map data comprises a geographic location.

16. The system of claim 15, wherein the geographic location comprises a telecommunications service area.

17. The system of claim 16, wherein the telecommunications service area comprises individual service areas.

18. The system of claim 16, wherein the telecommunications service area comprises a state.

19. The system of claim 16, wherein the telecommunications service area comprises a plurality of states.

20. The system of claim 14, wherein the telecommunications operational data comprises telecommunication service data associated with the geographic location.

21. The system of claim 14, wherein the display comprises a map display.

22. The system of claim 14, wherein the display comprises a tabular display.

23. The system of claim 14, wherein the plurality of identifiers comprise a graduated color scheme.

24. The system of claim 23, wherein the graduated color scheme comprises a plurality of colors corresponding to the ranking of importance, wherein the plurality of colors comprise a dark color, plurality of medium colors, and a light color.

25. The system of claim 24, wherein the dark color corresponds to a highest ranking in the ranking of importance.

26. The system of claim 25, wherein the light color corresponds to a lowest ranking in the ranking of importance.

27. The system of claim 26, wherein the plurality of medium colors correspond to a plurality of medium rankings in between the highest and lowest rankings in the ranking of importance.

28. The system of claim 14, wherein the plurality of identifiers comprise a gray scale shading scheme.

29. The system of claim 28, wherein the gray scale shading scheme comprises a plurality of shadings corresponding to the ranking of importance, wherein the plurality of shadings comprise a dark shading, plurality of medium shadings, and a light shading.

30. The system of claim 29, wherein the dark shading corresponds to a highest ranking in the ranking of importance.

31. The system of claim 30, wherein the light shading corresponds to a lowest ranking in the ranking of importance.

32. The system of claim 31, wherein the plurality of medium shadings correspond to a plurality of medium rankings in between the highest and lowest rankings in the ranking of importance.

33. The system of claim 14, further comprising a graphical user interface (GUI), wherein the GUI is used to present the data.

34. The system of claim 14, wherein the map display comprises a report title, a legend, a map scale bar, and a tool menu.
